(19) United States
(12) Patent Application Publication
(10) Pub. No.: US 2009/0050476 A1
(43) Pub. Date: Feb. 26, 2009

(54) Zr/ZrO2 Electrode and Producing Method Thereof and Integrated High Temperature and High-Pressure Chemical Sensor Composed by the Same

(76) Inventors: Ronghua Zhang, Beijing (CN); Shumin Hu, Beijing (CN); Xuetong Zhang, Beijing (CN)

Correspondence Address: MICHAEL N. LAU;LAU & ASSOCIATES, LLC, 2121 EISENHOWER AVENUE, SUITE 200, ALEXANDRIA, VA, 22314, US

(21) Appl. No.: 11/886,663

(22) PCT Filed: Mar. 21, 2006
(86) PCT No.: PCT/CN2006/000446

§ 371 Date: Sep. 19, 2007

(30) Foreign Application Priority Data
Mar. 21, 2005 (CN) 200510056407.7

(51) Int. Cl. G01N 27/30; G01N 27/27; G01N 27/407

(52) U.S. Cl. 204/401; 204/290.12; 29/825; 204/412; 427/77

(57) ABSTRACT

The invention involves a Zr/ZrO₂ electrode that consists of a piece of Zr wire and a ZrO₂ film formed over the surface of the part of the Zr wire for the use of measuring end in the probe section. An insulating layer and a sealing structure are put in place on the non-probe section and the non-conducting wire connection section of said electrode, while the Zr wire at the other end is applied for circuit connection. The invention also provides a type of integrated high-temperature/high-pressure chemical sensors, which includes one Zr/ZrO₂ electrode and also 2 to 5 electrodes that can combine with the Zr/ZrO₂ electrode to measure pH value, H₂ value, H₂S value and Eh value in high-temperature/high-pressure conditions, together constructing the integrated chemical sensors capable of measuring at least two kinds of parameters. The electrode and the integrated high-temperature/high-pressure chemical sensors work properly at the temperature range between 0 and 400 under the pressure up to 60 MPa and accurately measure various electrochemical parameters of liquid, displaying working stability and long lifespan. The electrode and chemical sensors can be fitted in high pressure reactors in laboratory for measuring and marking, as well as on detectors for measuring in actual high-temperature/high-pressure environments. The invention also presents the fabrication and construct process of the Zr/ZrO₂ electrode.

### TECHNICAL FIELD OF THE INVENTION

The invention involves a Zr/ZrO₂ electrode, construct process of said Zr/ZrO₂ electrode, and in particular, integrated high-temperature/high-pressure chemical sensors composed of Zr/ZrO₂ electrodes and several other electrodes; said chemical sensors are applied to perform real time measurement and capture of various electrochemical parameters at the same time.

### TECHNOLOGY BACKGROUND

Nowadays, chemical sensors used to detect electrochemical parameters of liquid in high temperature and high pressure conditions are solid sensors, which consist of measuring electrodes as well as reference electrodes. But none of the sensor products in current market is able to work at the temperature over 100° C. It is reported that solid sensors in study are hardly workable in such a high-temperature/high-pressure environment at the temperature range between 0 and 400° C. under 60 MPa (about 600 bars of atmospheric pressure). Electrodes are the major part of a chemical sensor. Therefore, enhancement of high-temperature/high-pressure resistant capability poses a tough challenge to the existing chemical sensor technology, and is also considered as a frontier subject in the field.

Defects of existing chemical sensors in study lie in following aspects. Firstly, materials for chemical electrodes in existing technology are not stable enough, such as the commonly used Cu/CuO electrodes or Ni/NiO₂ electrodes. Both Cu and Ni used in such electrodes have multiple electrovalences and in particular, become quite unstable in high-temperature/high-pressure conditions, leading to inaccurate measurement results. Additionally, reported electrodes and sealing structures of chemical sensors they construct are invalidated quite easily in high-temperature/high-pressure conditions, thus causing electrode damages or short measuring circuit and momentarily disabling sensors.

Other chemical sensors in study are only applied to measure single electrochemical parameter rather than multiple parameters of high-temperature/high-pressure liquid, which raises great inconveniences for resource and energy detection practice.

Currently, to meet the demand of real time measurement of multiple water parameters at deep sea floor for (including hydrothermal ore deposits) resources development and research in deep water and other similar high-temperature/high-pressure hydrothermal application, it is required to develop an integrated chemical sensor that can measure multiple parameters of hydrothermal fluid properly and accurately in high-temperature/high-pressure environments and is made to be both corrosion resistant and durable. The integrated chemical sensor is installed in deep sea high-temperature/high-pressure detectors as well as in high pressure reactor in laboratories to measure various chemical parameters of high-temperature/high-pressure solutions.

### DESCRIPTION OF THE INVENTION

The invention is provided to improve deficiencies of existing technology and present a high-temperature/high-pressure Zr/ZrO₂ electrode that is workable within the temperature range between 0° C. and 400° C. under 60 MPa and able to accurately measure multiple electrochemical parameters of liquid, displaying working stability and long lifespan.

The invention aims to further provide an integrated high-temperature/high-pressure chemical sensor that is composed of Zr/ZrO₂ electrodes and capable of accurately measuring pH value, H₂ value, H₂S value and Eh value in liquid. Another purpose of the invention is to present the construct method and process of said Zr/ZrO₂ electrode.

Purposes of the invention are achieved through following technical designs:

A. A Zr/ZrO₂ electrode includes a piece of Zr wire which is divided into a probe section at one end, a middle section and a conducting wire connection section at the other end. A ZrO₂ layer is coated over the surface of the Zr wire in said probe section, an insulating layer and a sealing structure are fitted in said middle section sequentially and a mechanical connection structure in said conducting wire connection section.

The aforesaid mechanical connection structure is: to sheathe the conducting wire section of the electrode with an easily weldable conductive metal canula, which is used for welding connection between the conducting wire and said conductive metal canula to form an electrode measuring circuit.

Such an insulating layer for the Zr wire can be made of insulating heat-resistant coating applied to the surface of said wire, and/or a polytetrafluoroethylene tube (PTFE tube) or a heat shrinkable PTFE tube sheathed over it.

The Zr/ZrO₂ electrode's sealing device over the insulting layer uses a sealing washer sheathed in place to seal up the electrode and the shell of the chemical sensor or through holes of the measuring and indication experimental devices used to measure or calibrate the electrode or the part among protection covers of sensors in field detection.

The sealing structure uses a sealing washer that is made of graphite-PTFE mixture and sheathed upon said electrode. A preferable sealing structure is the arrangement of alternately placing graphite-PTFE-mixed sealing washers and metal washers. Said arrangement can also include metal thread ferrules and nuts that screw into through holes on the chemical sensor shell. And said ferrules and nuts are placed upon the washers stated in prior sections. In practice, sealing between electrodes and such a shell is done by the thread ferrules and nuts along with combining threads and shoulders on through holes of the shell.

The Zr/ZrO₂ electrode presented by this invention uses Zr metal, which has quite stable chemical properties, particularly in high-temperature/high-pressure conditions. But in existing technology, the metal is rarely used to produce chemical sensors, and one of the reasons is its poor welding capability, making it hard to be welded to conductive metals. However, the invention provides a connection structure to mechanically attach an easily weldable metal with Zr wires, by which way solved the connection difficulty between Zr electrodes and conducting wires of the measuring circuit. The Zr/ZrO₂ electrode, as provided by this invention, with a sealing structure configuration of alternately placing sealing washers made of graphite-PTFE mixture and metal washers along with metal thread ferrules and nuts that screw into through holes on the shell of the chemical sensor, is screwed onto the shell and work within the temperature range between 0° C. and 400° C. under 60 MPa stably over a long period of time in practice.

In addition, existing technology can not form high-quality ZrO₂ film on Zr metal, resulting in Zr/ZrO₂ not being workable as electrodes for chemical sensors.

The construct process of the Zr/ZrO₂ electrode is provided by this invention as follows:

Zr wires with a diameter of φ1˜1.2 mms are used.

If using a Zr wire coated with organic carbon, then there is no need to cleanse it, which will be directly put into an alumina crucible with Au lining to get oxidized in melted NaCO₃ and coated with ZrO₂ film on its surface after reacted for 1-2 hours under the temperature of 890-900° C.

If using a normal Zr wires, cleansing procedure needs to be performed prior to the steps presented above. The cleansing procedure is: to burnish the surface of the Zr wire and then dip it into thin hydrochloric acid which will remove soluble matters on its surface, then rinse and rid its surface of organic pollutants and dust before drying it.

The way to construct the mechanical connection structure placed in the conducting wire connection section of the Zr/ZrO₂ electrode is:

To burnish the conducting wire connection section of the Zr/ZrO₂ electrode, and then cover with and press on the burnished end of such a electrode the conductive metal canula, therefore connect conductive metal pipes and conducting wires.

B. An integrated high-temperature/high-pressure chemical sensor, including a Zr/ZrO₂ electrode and also 2-5 electrodes capable of working with the Zr/ZrO₂ electrode to measure pH value, H₂ value, H₂S value and Eh value in high-temperature/high-pressure conditions; the electrodes are integrated to the shell of the sensor to jointly form an integrated chemical sensor capable of measuring at least two parameters mentioned above.

Using the Zr/ZrO₂ electrode to combine with other electrodes, can construct integrated high-temperature/high-pressure chemical sensors to simultaneously measure multiple parameters of high-temperature/high-pressure liquid;

Using Zr/ZrO₂ as the material for the measuring electrode and Ag/AgCl as reference electrodes to construct a chemical sensor capable of measuring pH value;

Using Zr/ZrO₂ as the material for the reference electrode and Ag/Ag₂S as measuring electrodes to construct a chemical sensor capable of measuring H₂S value;

Using Zr/ZrO₂ as the material for the reference electrode and Au (Pt) as measuring electrodes to construct a chemical sensor capable of measuring H₂ value;

In addition, using Au (Pt) as the material for the measuring electrode and Ag/AgCl as reference electrodes to build a chemical sensor capable of measuring Eh value;

Integrated high-temperature/high-pressure chemical sensors not only scientifically combine several types of electrodes into one chemical sensor, but also can simultaneously measure pH value, H₂ value, H₂S value and Eh value.

### B1)

A preferable technical design for the integrated high-temperature/high-pressure chemical sensor, which includes Au (or Pt) electrodes, Ag/AgCl electrodes and Ag₂S/Ag electrodes besides a Zr/ZrO₂ electrode, and is able to measure pH value, H₂ value, H₂S value and Eh value simultaneously, with insulating layers and sealing structures sheathed over said electrodes that are inserted in and fastened on through holes of a chemical sensor shell.

Structure of said Zr/ZrO₂ electrode is same as the technical design for the Zr/ZrO₂ electrode presented in prior sections.

The integrated high-temperature/high-pressure chemical sensors provided by this invention combine the Zr/ZrO₂ electrode with Au (or Pt) electrodes, Ag/AgCl electrodes and Ag₂S/Ag electrodes to form chemical sensors capable of measuring multiple electrochemical parameters in high-temperature/high-pressure liquid.

### B2)

Based on the four electrodes of such integrated high-temperature/high-pressure chemical sensors, YSZ/HgO/Hg electrodes also can be integrated into them to build a 5-electrode chemical sensor. In such chemical sensors, when YSZ/HgO/Hg electrodes and the Zr/ZrO₂ electrode work together as reference electrodes, and are combining with Au (or Pt) measuring electrodes, they are ready to obtain two H₂ content values for mutual measuring and calibrating; YSZ/HgO/Hg electrodes and the electrode work as measuring electrodes together, and matching with Ag/AgCl reference electrodes, they are ready to obtain two pH values for mutual measuring and calibrating; in addition, when using Au (or Pt) as measuring electrodes and Ag/AgCl as reference electrodes, the chemical sensor is capable of measuring Eh value.

Other measuring arrangements of such a chemical sensor's electrodes are same as the examples listed above, which are applied to measure said four kinds of parameters.

### B3)

A preferable technical design for an integrated high-temperature/high-pressure chemical sensor includes Au (or Pt) electrodes and Ag/AgCl electrodes as well as the Zr/ZrO₂ electrode, being capable of measuring pH and Eh value at the same time.

In such a design, the Zr/ZrO₂ electrode combined with Au (or Pt) electrodes are used to measure H₂ value of the liquid; while the Au (or Pt) electrodes combined with Ag/AgCl electrodes are used to measure oxidation reduction potential Eh value of liquid; and the Zr/ZrO₂ electrode combined with Ag/AgCl electrodes are used to measure pH value of liquid. If pairing said three electrodes alternately, the chemical sensor is used to measure three kinds of electrochemical parameters with a higher level of integrity.

In the invention, Ag/AgCl electrodes and Au (Pt) electrodes also can build another high-temperature/high-pressure chemical sensor:

A high-temperature/high-pressure chemical sensor including Au (or Pt) electrodes and Ag/AgCl electrodes which are covered with an insulating layer and sheathed with a sealing structure, packed and sintered in through holes of a chemical sensor shell.

The chemical sensor can measure oxidation reduction potential Eh value of liquid.

Except for the Zr/ZrO₂ electrode, other electrodes provided in this invention have different characteristics to make the chemical sensors work well in the high-temperature/high-pressure environment.

The structure design for said Ag/AgCl electrode is:

Placing AgCl film on Ag wire at the probe section of the electrode and insulting layers at non-probe sections and non-conducting wire sections of said electrode, with Ag wire at the other end of the electrode to connect conducting wires of measuring circuit while being in use. Over such an insulting layer is a sealing structure put in place to seal spacing between electrodes and through holes of the chemical sensor shell.

Such an insulating layer can be made of insulating heat-resistant coating and/or PTFE tubes with the insulated Ag wire, or heat-shrinkable PTFE tubes.

Such a sealing structure is achieved as follows: the graphite-PTFE-mixture sealing washer is fitted around the insulting heat-resistant coating in the middle section; electrodes are sheathed below such sealing washers by the insulating PTFE tube; the metal sealing washers is fitted on the PTFE tube; the heat shrinkable PTFE tube and the stainless steel tube are sheathed on electrodes above the graphite-PTFE-mixture sealing washer; the metal ferrule is fitted on the middle part with taper-shaped through holes at its center and propping with its lower end upon the metal sealing washers; such graphite-PTFE-mixture sealing washers are supporting against through hold shoulders of the metal ferrules for the sealing purpose; a sealing pressure part is sheathed on the stainless steel canula above such a metal ferrule by screwing into the wider holes in the upper part of such a metal ferrule, to construct a two-fold baton sealing structure.

Another structure design for such an Ag/AgCl electrode includes a piece of Ag wire which is divided into the probe section at one end, the middle section and the conducting wire connection at the other end. The part of Ag wire on the probe section is placed into a ceramic tube (zirconia ceramic tube or alumina ceramic tube or ordinary ceramic tube) with porous layers formed by sintered cement sealed at both of its ends. On the Ag wire is a layer of AgCl that is made by melting solid AgCl powder. The probe section of the AgCl/Ag electrode is packed behind the sintered cement layer in the ceramic tube, while the middle section and the conducting wire connection pass through the sintered cement layer and connect with physical conducting wires at its end for circuit board connection. The probe section of such an electrode has a three-zone structure, cement-AgCl/Ag-cement. The Ag wire in the middle section has around it an insulating layer that can be made of heat-resistant insulating coating and/or an insulating PTFE tube or a heat shrinkable PTFE tube sheathed on the Ag wire; the sealing structure over the exterior of the insulating layer is for sealing the spacing between electrodes of the sensor and through holes of the high pressure reactor, or for sealing the spacing between the sensor and the protection shell in field measuring. Such a sealing structure can be sealed washers made of graphite-PTFE mixture, but preferably, placing graphite-PTFE-mixture sealing washers and metal washers alternately. The sealing structure also includes the metal thread ferrule and/or nut that can be screwed into through holes on the sensor shell. The sealing structure attaching the electrodes to the sensor shell, is used to attach the electrodes with through holes of the high pressure reactor that is for measuring and marking experimental devices.

Choosing one for the Ag/AgCl electrode from the two said structures.

To fabricate an Ag/AgCl electrode, one of the following process can be adopted:

The first way to produce the Ag/AgCl electrode is: to melt AgCl at the temperature of 470° C.˜550° C. and submerge the probe section of the Ag wire into melted AgCl, forming an AgCl film over the Ag wire before pulling it out.

The other way to produce Ag/AgCl electrodes is: to insert the probe section of the Ag wire into the zirconia ceramic (or Al₂O₃ ceramic or ordinary ceramic) tube that contains solid AgCl powder in its interior chamber with cement sealing at both ends of the tube and then heat parts mentioned above for 1 to 3 hours at the temperature of 500-550, after which the solid AgCl powder will melt and form an AgCl coating over the Ag wire and cement sealing both ends of the ceramic tube will form porous sintered layers; during this process, the Ag wire as one end of the probe section is packed behind the sintered cement layer of the ceramic tube, while the other end of the Ag wire is passing through the sinter cement layer for conductive connection.

The structure of such an Au electrodes is:

Said Au electrode includes a quartz rod, a piece of alloy wire with similar thermal expansion coefficient and a piece of Au wire; the alloy wire, which is Kovar, and the Au wire are embedded in the quartz rod from one end to the other and attach to each other in the rod; a part of the Au wire holds out of the measuring end of the quartz rod, preferably attaching to a gold flake that forms a cylindrical shape for the purpose of enlarging its contact interface with the medium to be measured; a part of the alloy wire holds out of the other end of the quartz rod to connect physical conducting wires; the alloy wire and the Au wire are packed and sintered in the quartz rod; the alloy wire that holds out of the quartz rod is coated with an insulating layer by insulating lacquer and/or a PTFE tube or a heat shrinkable PTFE tube; sealing structure is fitted over the insulating layer and on the sidewall of the quartz rod.

The sealing structure can be graphite-PTFE-mixture sealing washers fitted over the insulating layer and on the quartz rod. A preferable design for the sealing structure on the quartz rod is to alternately place graphite-PTFE-mixture sealing washers and metal washers.

The sealing structure also includes metal thread ferrules and/or nuts pressing upon the sealing washers and their exterior sidewalls, in which shoulders formed by stepped holes on ferrules and/or nuts press on said sealing washers.

In practice, the sealing for the clearance between electrodes and said shell is done by connecting such thread ferrules and/or nuts to combine thread and shoulders on the through holes of said chemical sensor shell.

The Au electrode is sealed by using the quartz rod to sheathe the gold electrode's Au, wire and the alloy wire and choosing an type of alloy wire with thermal expansion coefficient similar to quartz's to connect with the Au wire, making said electrode able to work properly in high-temperature/high-pressure conditions.

The way to fabricate the Au measuring electrode is as follows:

The preparation and fabrication of Au electrodes are done by: selecting a type of alloy wire, which shall be Kovar metal wire, with thermal expansion coefficient similar to quartz's; putting such a piece of alloy wire along with a piece of Au wire inside the quartz rod to heat and sinter, which makes the alloy and Au wires and the quartz rod sintered and packed; holding out a part of the Au wire from one end of the rod to attach a gold flake that is bended to the cylindrical shape; holding out a part of the alloy wire to attach the conducting wire.

The structure design for said Ag/Ag₂S electrode is:

The structure of said Ag/Ag₂S electrode is: the part of Ag wire in the probe section is placed into a ceramic tube (zirconia ceramic tube or alumina ceramic tube or ordinary ceramic tube) with porous layers formed by sintered cement sealed at both of its ends and a solid Ag₂S layer inside the tube and around the Ag wire formed by melting solid Ag₂S powder; the probe section of the Ag/Ag₂S electrode is packed behind the sintered cement layer in the ceramic tube, while the conducting wire connection passes through the sintered cement layer and connects with physical conducting wires for circuit board connection. The electrode has a three-zone structure, i.e. cement-Ag/Ag₂S-cement.

Furthermore, the part of the Ag wire not connected to the conductive wire but going through said sintered cement layer has an insulating layer in place that is insulating heat-resistant coating and/or an insulated PTFE tube or a heat shrinkable PTFE tube sheathed on the Ag wire. A sealing structure, which is graphite-PTFE-mixture sealing washers, is sheathed over said insulating layer. A preferable sealing structure design is the arrangement of alternately placing graphite-PTFE-mixture sealing washers and metal washers.

The sealing structure also includes metal thread ferrules and/or nuts pressing upon the sealing washers, in which shoulders formed by stepped holes on ferrules and/or nuts press on said sealing washers.

In practice, the sealing of the clearance between electrodes and said shell is done by attaching such thread ferrules and/or nuts with matching thread and shoulders on the through holes of said chemical sensor shell.

The structure design for said YSZ/HgO/Hg electrode is:

Said YSZ/HgO/Hg electrode (also called YSZ/HgO/Hg ceramic probe) includes a ZrO₂ ceramic tube containing Y₂O₃ with one end sealed and the other open, in which Hg/HgO mixture is filled into the lower part of the ceramic tube at a weight ratio range of 1-1.5:1; a piece of platinum wire is inserted into said ceramic tube with its lower part buried into said Hg/HgO mixture and its upper part holding out of the ceramic tube to connect with a physical conducting wire or directly work as a physical conducting wire; filling substance, which is silicate substance involved in no electrochemical reaction and solidified when water is added in, is put into the upper part of the ceramic tube above the Hg/HgO mixture; the filling substance will push down the Hg/HgO mixture firmly; PTFE or graphite-PTFE-mixture washers are fitted on the ceramic tube end from where the Pt wire holds out to have said end sealed; the insulating layer is fitted over the non-conducting wire connection part of the Pt wire of said ceramic tube, which can be done with insulating heat-resistant coating and/or an insulating PTFE tube or a heat shrinkable PTFE tube sheathed on the Pt wire; the sealing structure fitted over said insulating layer is used to seal the clearance between sensor electrodes and through holes of the high pressure reactor, or between the sensor and the detector shell in field measuring.

Height of the Hg/HgO mixture filled into said ceramic tube depends on the electrode length required in the actual application environment, preferably 2-3 cm.

The ceramic tube contains ZrO₂ as its major component along with 9% of Y₂O₃ stabilizer. Generally the ceramic tube is called “Y₂O₃Stabilized ZrO₂ Ceramic Tube”.

The silicate substance as filling above Hg/HgO mixture uses cement slurry that has a cement to water ratio of 1:1. A preferable design for the filling substance is to use a mixture of cement slurry and Al₂O₃ ceramic with a diameter of φ2-4 mms or average ceramic pipe pipe nipple with a length of 3-5 mms. Said ceramic pipe nipple and cement slurry preferably have a volume ratio of 1:1, which can be adjusted as necessary. Adding ceramic pipe nipple into cement slurry can enhance strength and consistency.

The sealing structure for the part between said ceramic probe (YSZ/HgO/Hg electrodes) and metal, such as through hole wall of those on high pressure reactors, or the connection part of a sensor and a detector shell in field measuring is done by sheathing graphite or graphite-PTFE-mixture sealing washers on said ceramic tube. A preferable design is the configuration of alternately placing graphite sealing washers and metal washers pressed and fastened by metal thread ferrules and nuts to screw onto high-pressure reactor or corresponding protection shells, i.e. the extrusion sealing structure.

The invention also announces a type of integrated high-temperature/high-pressure sensors, which in the sensor fabricated by the Zr/ZrO₂ electrode, the Ag/AgCl electrode, the Ag/Ag₂S electrode and the Au (or Pt) electrode, uses YSZ/HgO/Hg electrode to replace the Zr/ZrO₂ electrode. In addition, it also presented another sensor that replace Zr/ZrO₂ with YSZ/HgO/Hg in the sensor fabricated by the Zr/ZrO₂ electrode, the Ag/AgCl electrode and the Au (or Pt). Structures for these electrodes are the same as those stated above, so do the structures to build sensors.

The advantage of the sensor is to be more adaptable to high temperature conditions, and YSZ/HgO/Hg electrodes have a longer lifespan and become more durable at the temperature of 200-400.

In the chemical sensors constituted by the Zr/ZrO₂ electrode, the Ag/AgCl electrode, the Ag/Ag₂S electrode and the Au (or Pt) electrode as presented by the invention, the sealing structure covering said electrodes and said chemical sensor shell, which uses graphite washers, copper washers or stainless steel washers or graphite-PTFE-mixture washers of metal sealing washers for sealing, has a better effect; by modifying sizes of ferrules and metal washers, such as copper washers, stainless steel washers, graphite washers, graphite-PTFE-mixture washers or metal sealing washers, and choosing washers with different properties, the chemical sensors using and fabricated by the measuring electrodes can take different shapes and sizes to fit in high pressure reactors with different properties and sizes to work in a stable high-temperature/high-pressure environment (with a temperature up to 400 and pressure up to 60 MPa).

The integrated high-temperature/high-pressure chemical sensors constructed by the Zr/ZrO₂ electrode and by said electrode along with the Au (or Pt) electrode, the Ag/AgCl electrode and the Ag/Ag₂S electrode can operate at the temperature range between 0 and 400 and under 60 MPa to accurately measure multiple electrochemical parameters in the liquid and display working stability and long lifespan. The measuring electrodes and chemical sensors can be fitted in high pressure reactors in laboratory for measuring and marking, and also can be mounted to detectors to perform real time measuring for high-temperature/high-pressure liquids in actual high-temperature/high-pressure environments.

### BRIEF DESCRIPTION OF THE DRAWINGS

With reference to the accompanying drawings, the following paragraphs will elaborate the invention.

FIG. 1 is the schematic view of the Zr/ZrO₂ electrode presented by the invention;

FIG. 2 is the schematic view of one of the structure designs for the Ag/AgCl reference electrode in the integrated high-temperature/high-pressure chemical sensors presented by the invention;

FIG. 3 is the schematic view of another structure design for the Ag/AgCl reference electrode in the integrated high-temperature/high-pressure chemical sensors presented by the invention;

FIG. 4 is the schematic view of the structure design for the YSZ/HgO/Hg electrode in the integrated high-temperature/high-pressure chemical sensors presented by the invention;

FIG. 5 is the schematic view of the Au electrode in the integrated high-temperature/high-pressure chemical sensors presented by the invention;

FIG. 6 is the schematic view of the Ag/Ag₂S electrode in the integrated high-temperature/high-pressure chemical sensors presented by the invention;

FIG. 7 is the schematic view of one of the integrated high-temperature/high-pressure chemical sensors presented by the invention;

FIG. 8 is the schematic view of another integrated high-temperature/high-pressure chemical sensor presented by the invention;

### DETAILED DESCRIPTION

### Example 1

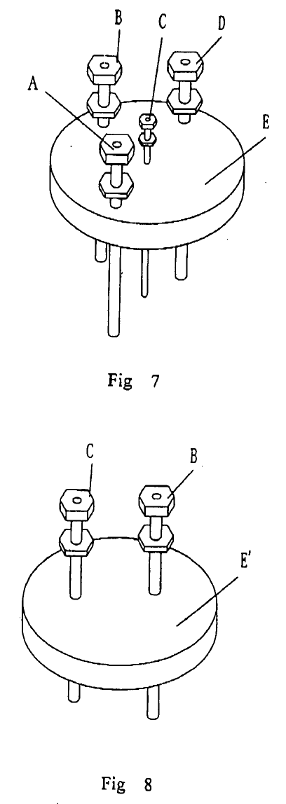

An integrated high-temperature/high-pressure chemical sensor, as illustrated in FIG. 7, includes a Zr/ZrO₂ electrode A, an Au electrode B, an Ag/AgCl electrode C and an Ag/Ag₂S electrode D, over which an insulating layer and a sealing structure are sheathed while being inserted into through holes of the shell of chemical sensor box E for sealing and fixing;

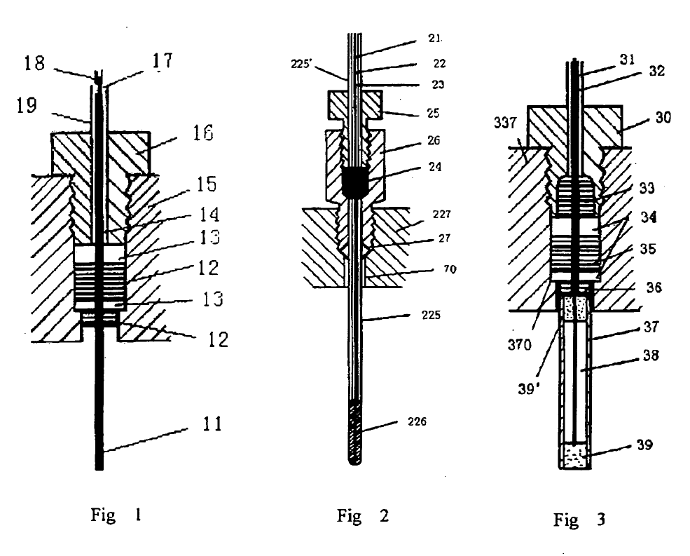

As illustrated in FIG. 1, the Zr/ZrO₂ electrode is composed of Zr wire 17 and ZrO₂ film 11 formed over the Zr wire's surface. The end of the Zr wire coated with ZrO₂ film is the probe end of said electrode sensor; the Zr wire 17's the other end connects with circuit; the middle section of the Zr wire 17 is covered with an insulating coating layer and sheathed with a heat shrinkable PTFE tube 14. Stainless steel tube 19 is sheathed on the heat shrinkable PTFE 14. For the Zr/ZrO₂ electrode, said insulating layer, i.e. the heat shrinkable tube, has a sealing device in place, which is sealing washers sheathed on it in such a manner: from top to bottom, alternately placing graphite-PTFE-mixture washers 12 and stainless steel washers 13 on the heat shrinkable PTFE tube with metal screw nut 16 pressed on the top stainless steel washer. While inserting the electrode into the taper-shaped through hole on sensor shell 15, the stainless steel washer at the lower position supports against the through hole shoulder. Bottom sealing washer 12 has a diameter smaller than that of the stainless steel washer and is placed in the smaller through hole below the through hole shoulder. Screw nut 16 matches thread with the through hole, while stainless steel washer 13 at the lower position supports on the through hole shoulder. By tightening metal screw nut 16, washer 13 and 12 can be pressed tight to firmly seal the clearance between the electrode and the through hole. The connection structure between the Zr/ZrO₂ electrode and the metal conducting wire is: sheathing the electrode end to connect power with an easily weldable, such as copper or aluminum, conducting metal shell 18. To form the electrode measuring circuit, just welding the conducting wire with said conducting metal shell.

The construct process for the Zr/ZrO₂ electrode is as follows:

### 1. Preparing the Zr Wire:

Using Zr wires with a diameter of φ1-1.2 mms; using rough/fine sandpaper to burnish surface of the Zr wire and then using quartz sandpaper to polish said surface; dipping said wire into the thin hydrochloric acid to remove the soluble and rinsing it with distilled water; putting the wire into acetone and cleaning its surface with the ultrasonic cleanser for half a hour, by which removes organic pollutants and dust residing on the surface; then using n-Hexane to wash it clean the ultrasonic cleanser for another half a hour; rinsing it with distilled water after taking it out; air-drying the wire or drying it at the temperature of 80.

If the Zr wire with organic carbon coating is adopted, the aforesaid surface processing is not required.

### 2. Forming Zro₂ Film on the Zr Wire:

Putting the probe end of the processed or organic-carbon-coated Zr wire into the alumina crucible with Au lining to get oxidized in melted NaCO₃ for 1 to 1.5 hours at the temperature of 890-900.

During the process to form ZrO₂ film in melted NaCO₃, the key points are heating temperature and the time for stable high-temperature status.

Another end of the Zr/ZrO₂ electrode is covered with insulating coating and sheathed with a heat shrinkable PTFE tube which have the sealing washer 12 and the stainless steel washer 13 fitted exteriorly.

The conducting wire connection end of the Zr/ZrO₂ electrode does not weld directly but use mechanical connection structure to attach with the conducting wire. The mechanical connection structure and the connection manner of the Zr wire are:

Burnishing the Zr wire end to be connected with the metal conducting wire and then cover and press the conductive metal canula on said burnished end of the electrode, in which the conducting metal canula connects with the conducting wire.

Using the Zr/ZrO₂ electrode can accurately measure electrochemical parameters of liquid in high-temperature/high-pressure conditions within a wide temperature range.

### The Structure Design for Said Ag/AgCl Electrode:

As illustrated in FIG. 2, the Ag/AgCl electrode comprises of Ag wire 21 and AgCl film 226 over the lower part of Ag wire 21, and the lower part of the Ag wire is used as a probe and the section not working as a probe and non-conducting wire connection section are coated by an insulating layer; in this example, the insulating layer is sealing and insulating lacquer 22, over which heat shrinkable PTFE tube 23 is fitted; on the heat shrinkable tube are sheathed graphite-PTFE-mixture sealing washer 24, stainless steel tube 225′ over sealing washer 24 and PTFE tube 225 below sealing washer 24. Upon PTFE tube 225, metal sealing washer 27 is fastened in place which has one sloped upper end-surface and one sloped lower end-surface. Sealing thread insert 26 is sheathed on metal sealing washer 27 and with its exterior thread, screwed into through hole 70 on chemical sensor shell 227, in which the lower part of the thread supports against the sloped upper end-surface of metal sealing washer 27 and a sloped shoulder of one of the stepped center holes props against the underside of sealing washer 24. While the electrode is inserted into through hole 70 on chemical sensor shell 227, metal sealing washer 27 supporting against the matching sloped shoulder on the through hole is pressed, forming the first sealing structure of the fold baton sealing structure. For the stepped center through hole on sealing thread insert 26, its upper part has a larger hole diameter with thread on its interior sidewall, and its lower part of the hole is unthreaded, while there is a sloped shoulder between the threaded part and the unthreaded part; the stepped center hole of sealing thread insert 26 contains graphite-PTFE-mixture sealing washer 24, which is sheathed on the heat shrinkable tube over the electrode, propping against said shoulder; sealing pressure part 26 is sheathed over stainless steel tube 225′ on sealing thread insert 26, in which the part with exterior thread on sealing pressure part 25 is inserted into the section with a larger diameter in the stepped center through hole of sealing thread insert 26, matching with interior thread of sealing thread insert 26. Just by tightening sealing pressure part 25 to press sealing washer 24, the second sealing structure of the fold baton sealing structure will be put in place. Thus, fitted over the heat shrinkable tube is a two-fold baton sealing structure.

Said Ag/AgCl electrode can be built through following steps: melting AgCl at the temperature of 470˜550 (470 or 550 or 500) and then dipping the probe section at the lower part of the Ag wire into the melted AgCl to form an AgCl film over the Ag wire; The time required to perform the steps depends on temperature of the processing environment and the melted substance, which usually takes 3 to 15 seconds till AgCl coating formed over its surface; using routine methods to fasten said insulating layer on the upper part of the electrode, while the upper end of the Ag wire needs to hold out of the insulating layer for the connection with the conducting wire to form circuit.

Detailed steps are:

### 1. Preparing the Ag Wire:

Using super-fine quartz sandpaper to burnish the Ag wire; removing pollutants or oxide on its surface by having it cleansed in thin hydrochloric acid first and then rinsed in distilled water; putting it into acetone solution and cleansing it with the ultrasonic cleanser for more than half an hour; rinsing dust and organic substances resided on it surface and then putting it into n-Hexane solution and cleansing it with the ultrasonic cleanser for more than half an hour again; finally taking it out for air-dry or dry at the temperature of 80.

### 2. Forming AgCl Film on the Ag Wire:

Heating chemically pure AgCl powder into a ceramic crucible at the temperature of 470˜550, which melts the powder in basically anoxia conditions; putting the Ag wire processed as Step 1 into the melted AgCl and waiting for the AgCl film to form before pulling it out.

### 3. Constructing the Sealing Structure for the Ag/AgCl Electrode:

Doping the 1 mm-diameter Ag wire with insulating coating and sheathing it with a heat shrinkable PTFE tube; then fitting said sealing device; using a PTFE canula to perform the “baton” dual sealing as illustrated in FIG. 1; fitting copper (or stainless steel) ferrule 27 on PTFE tube 23 as the first sealing; the second sealing is done by using stainless steel tube 225′ above said PTFE tube 23; between the two φ3 mm tubes made of different materials, fitting a “baton” joint sealing component 24 with the stainless steel tube sheathed over the upper part of the heat shrinkable PTFE tube 23 around said component and the PTFE tube 225 over the lower part of said heat shrinkable PTFE tube 23; then adding stainless steel ferrule 25 and 26 for sealing. The sealing structure can ensure the resistance against the high temperature of 250 and the high pressure of 60 MPa.

the temperature at which the AgCl powder is melt in the process of forming AgCl film depends on the AgCl in use, and said powder is heated to any temperature as long as it is melted.

The structure design for said Ag/AgCl electrode also can be:

As illustrated in FIG. 3, the part of Ag wire 31 as the probe section of the Ag/AgCl electrode is placed in zirconia (YSZ) ceramic 37 with porous layers 39 and 39′ formed by sintered cement sealed at both of its ends, where there is AgCl film 38 formed by melting solid AgCl powder; the insulating layer heat shrinkable PTFE 32, is sheathed over the upper part of the Ag wire which is neither the probe section nor the conducting wire connection section; there is a sealing structure fitted in place over the insulating layer, which, including sealing washer 36, two stainless steel washers 34 and sealing washer 35 clamped between the stainless steel washers 34, are sheathed over heat shrinkable 32; fastening thread insert 30 sheathed above stainless steel washer 34 has a concaved end-surface at its bottom that forms a sealing chamber [M1], in where sealing washer 33 is placed with its underside propping against stainless steel washer 34; the clearance between the electrode and the high pressure reactor can be sufficiently sealed with said “baton” sealing structure of three sealing washers 33, 35, 36 by inserting the probe of said sensor into thread hole 370 on high pressure reactor 337 and then tightening fastening thread insert 30; located at the bottom of ceramic 37, sintered cement agglomerate 39 seals the lower part of, and probe section 38 of electrode 31 in, ceramic tube 37; sintered cement agglomerate 39 is porous substance, which not only allow liquid to permeate through and contact the sensor's electrode in ceramic tube 37, ensuring said chemical sensor work properly, but also well protect the electrodes to reduce electrode loss and extend their lifespan; located at the interior of the upper end of ceramic tube 37 and corresponding to the top of probe section 38, there is also sintered cement agglomerate 39′ that seals the upper part of ceramic tube 37, effectively separating the electrodes and walls of the high pressure reactor, prevent the possible short circuit caused by electrode erosion and further enhance the lifespan of the sensor.

In this example, the three-fold “baton” sealing structure which employs sealing washer 36 on sintered cement agglomerate 39′, sealing washer 35 between two stainless steel washers 34 and sealing washer 33 between stainless steel 34 and fastening thread insert 30, dependably seal the spacing between Ag/AgCl and through holes. There is also sintered cement agglomerate that seals the upper part of the ceramic tube and is fitted with sealing washer 36, by which way a better effect can be attained than that from directly placing sealing washers on the ceramic tube. Fitting ferrule sealing structure between two stainless steel washers avoids problems such as displacement of seal washers to ensure dependable sealing, while sealing washer 33 at the topmost position is limited in the cavity on fastening thread insert 30, and as the last sealing structure, its sealing performance is quite dependable. Therefore, the sealing structure achieves favorable sealing in the environment with high-temperature/high-pressure chemical media.

While in use, the Ag wire part at the upper part of the reference electrode Ag/AgCl in the two structures mentioned above needs to connect with the physical conducting wire and then the circuit. Thickness of AgCl of the Ag wire used to produce reference electrodes does not influence the measuring. The Ag wire with a diameter of 0.5-1 mm is proved to be more firm

The construct process of said Ag/AgCl electrode structure is:

1. Preparing of the Ag Wire: same as the way to process Ag wires for the Ag/AgCl electrode with the prior structure.
2. Forming a AgCl film on the Ag wire:

The lower part of the Ag wire is embedded into the zirconia (YSZ) ceramic tube (or Al₂O₃ or ordinary ceramic tube). The ceramic tube is packed by cement at both ends, making solid AgCl powder melted by heating in anoxia conditions to form a film over the Ag wire and sinter cement into porous cement agglomerate.

As for the heating temperature and time while constructing the sealing structure for the Ag/AgCl electrode, there are other options:

Heating the aforesaid components for 3 hours at the temperature of 500.

Heating the aforesaid components for 1 hour at the temperature of 550.

Heating the aforesaid components for 1.5 hours at the temperature of 520.

The AgCl/Ag electrode produced by this manner can form a more durable cement-AgCl/Ag-cement structure in the open-ended ceramic tube.

### 3. Construction of the Sealing Structure for the Ag/AgCl Electrode:

Doping the 1 mm-diameter Ag wire with insulating coating and sheathing it with a heat shrinkable PTFE tube; then using graphite-PTFE-mixture sealing washers 35 and 36.

Over the insulating layer at the upper part of the Ag/AgCl electrode in the processed ceramic tube with the cement-AgCl/Ag-cement three-zone structure, graphite-PTFE-mixture sealing washer 36, stainless steel washer 34, graphite-PTFE-mixture sealing washer 35, stainless steel washer 34 and graphite-PTFE-mixture sealing washer 33 are sheathed in turn; on sealing washer 33, a sealing washer is sheathed over the heat shrinkable tube of the electrode; fastening thread insert 30 with a cavity formed by its concave end-surface at the underside is sheathed on stainless steel washer 34; graphite-PTFE-mixture sealing washer 33 is placed in said cavity with its lower part supporting against stainless steel washer 34; by inserting the constructed AgCl/Ag sensor probe into the through thread hole on sensor 337 and then tightening fastening thread insert 30, said sealing washers 33, 35 and 36 can form the three-layer “baton” sealing structure. The sealing structure built in such a manner can endure high temperature and high pressure at the temperature of 400 and under the pressure of 60 MPa.

In the condition of 400/60 MPa, washers made of 400 tolerant coating and artificial graphite are used for the sealing purpose. The connection is done by using graphite washers or graphite-PTFE-mixture washers and stainless steel washers together to seal. Putting them in a M20×1.5, M10×1, M8×1 metal fitting.

Materials used to make said graphite-PTFE-mixture sealing washer are average goods that can be bought at market.

As illustrated in FIG. 5, said electrode, including quartz 48, Kovar alloy wire 41 with thermal expansion coefficient similar to that of quartz's, alloy wire 41 and Au wire 411. Alloy wire 41 and Au wire 411 are embedded in the quartz rod 48 from one end to the other and weld to each other in the rod, forming a welding structure 412; a part of Au wire 411 holds out of the measuring end of quartz rod 48 and attaches to gold flake 49 that forms a cylindrical shape; and a part of alloy wire 41 holds out of the other end of quartz rod 48 to connect with physical conducting wires (not illustrated in the figure); both ends of said quartz rod are sealed; the metal wire holding out of quartz rod 48 has an insulating layer 42 which is composed of insulating varnish gum and a heat shrinkable PTFE tube; sealing structures are fitted in place over the insulating layer and the sidewall of the quartz wall for sealing the clearance between the sensor electrode and the sensor through holes.

The sealing structure is: sheathing insulating layer 42 over the part of metal wire 41 that holds out of quartz 48 with graphite-PTFE-mixture sealing washer 43; sheathing two stainless steel washers 44 on quartz rod 48 and placing graphite washer or graphite-PTFE-mixture washer 45; placing metal thread insert 46 on the quartz rod, which has a taper-shaped through hole; quartz 48 is inserted in the thinner end of the through hole; stainless steel 44 at the lower position sheathed on the quartz rod supports against the shoulder of the taper-shaped through hole in metal screw nut 46; at the lower middle part of screw nut 40, there is a concave chamber; thread at the lower part of metal screw nut 40 matches that of the upper part of metal thread insert 46; the convex end-surface of the thread insert is sheathed on quartz 48 and pressed upon stainless steel 44, subsequently pressing sealing washer 45 to seal; the concave end-surface in the middle part of the screw nut is pressed upon graphite-PTFE-mixture washer 43 on the outlet of the quartz tube; inserting quartz 48 with said sealing device into the stepped through hole of high pressure reactor 410; ring grooves are fitted on the through hole shoulder with graphite washer 47 placed in the through hole; metal thread insert 46, which has same the bottom end-surface shape as the stepped through hole on the sensor shell does, supports against said graphite washer 47 with its bottom end-surface; thus the three-layer extrusion sealing structure is constructed by using graphite washer 47, stainless steel washer 44, graphite or graphite-PTFE-mixture washer 45 and stainless steel washer 44, and graphite washers and graphite-PTFE-mixture washer 43.

The structure for the Pt electrode is basically same as that for the Au electrode, only needs to replace Au with Pt.

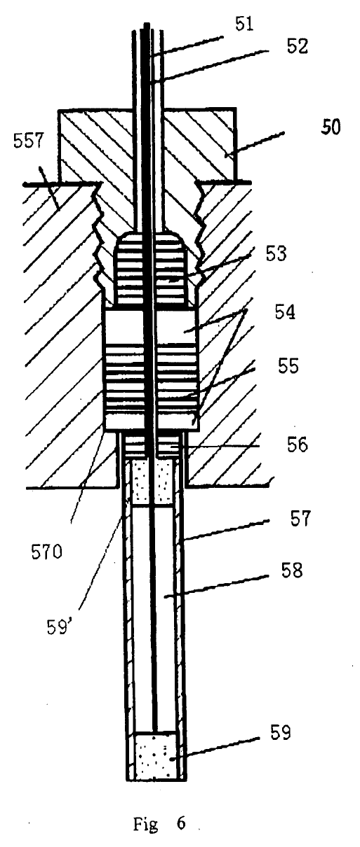

As illustrated in FIG. 6, the structure of the Ag₂S/Ag electrode is basically same as that of the Ag/AgCl electrode with the three-layer structure and is made of cement-Ag₂S/Ag-cement three-zone structure in an open-ended ceramic tube with its one end connecting to the Ag wire and then the physical conducting wire.

As illustrated in FIG. 6, the lower part of Ag wire 51 of the Ag₂S/Ag electrode is sheathed by alumina ceramic tube 57; the Ag wire inside ceramic tube 57 is coated with Ag₂S film 58; porous sintered cement agglomerates 59 ad 59 seal both ends of the ceramic tube; heat shrinkable PTFE tube 52 with an insulating layer is fitted over the upper half of the Ag wire that is neither the probe section nor the conducting wire connection section; said insulating layer has a sealing structure in place, which are sealing washer 56, two stainless steel washer 54 and sealing washer 55 clamped between sealing washers 54 sheathed on heat shrinkable tube 52; fastening thread insert 50 is fitted on stainless steel washer 54 and has a concaved end-surface at its bottom, forming a sealing cavity in which sealing washer 53 is placed; the lower part of fastening thread insert 50 supports against stainless steel washer 54; inserting the sensor probe into through thread hole 570 on sensor 557 and tightening fastening thread insert 50; through the three-layer “baton” sealing structure composed of said washers 53, 55 and 56, the clearance between the electrode and the high pressure reactor is well sealed. Sintered cement agglomerate 59 placed at the bottom of ceramic tube 57 seals the lower end of the ceramic tube, packing the lower probe section of electrode 51 into ceramic tube 57. Sintered cement agglomerate 59 is porous substance, which not only allows liquid to be measured to permeate into ceramic tube 57 and contact the sensor electrode, making the chemical sensor work properly, but also well protects the electrode to reduce its depletion and extend its lifespan. Clotted at the interior of the upper end of ceramic tube 57 and corresponding to the top of the probe section, there is also sintered cement agglomerate 59′ that seals the upper part of ceramic tube 57, effectively separating the electrodes and walls of the high pressure reactor, prevent the possible short circuit caused by electrode erosion and further enhance the lifespan of the sensor.

In this example, the three-fold “baton’ sealing structure which employs sealing washer 56 on sintered cement agglomerate 59′, sealing washer 55 between two stainless steel washers 54 and sealing washer 53 between stainless steel 54 and fastening thread insert 50, can dependably seal the clearance between Ag₂S/Ag and through holes. There is also a sintered cement agglomerate that seals the upper part of the ceramic tube and is fitted with sealing washer 56, by which way a better effect can be attained than that from directly placing sealing washers on the ceramic tube. Fitting ferrule sealing structure between two stainless steel washers can avoid problems such as displacement of seal washers to ensure dependable sealing, while sealing washer 53 at the topmost position is limited in the cavity on fastening thread insert 50, and as the last sealing structure, its sealing performance is quite dependable. Therefore, the sealing structure can achieve favorable sealing in the environment with high-temperature/high-pressure chemical media.

While in use, the Ag wire part at the upper part of the electrode Ag₂S/Ag in the structure design mentioned above needs to connect with the physical conducting wire and then the circuit. Thickness of the Ag wire used as reference electrodes does not influence the measuring. A dependable choice will be the Ag wire with a diameter of 0.5˜1 mm.

### Example 2

A high-temperature/high-pressure chemical sensor, as illustrated in FIG. 8, including Au electrode B and Ag/AgCl electrode C which are sheathed with an insulating layer and a sealing structure and packed and sintered on through holes of chemical sensor shell E. In addition, the Au electrode can be replaced with the Pt electrode with the exactly same structure.

The structure design for Au electrode B and Ag/AgCl electrode C is same as that in Example 1.

### Example 3

Based on the four electrodes of such integrated high-temperature/high-pressure chemical sensors, YSZ/HgO/Hg electrodes also can be integrated into them to build a 5-electrode chemical sensor. Its structure is similar to that in Example 1. In such chemical sensors, YSZ/HgO/Hg electrodes and the Zr/ZrO₂ electrode work as reference electrodes together, and matching with Au (or Pt) measuring electrodes, they are ready to obtain two H₂ content values for mutual measuring and marking; at the same time, YSZ/HgO/Hg electrodes and the Zr/ZrO₂ electrode work as measuring electrodes together, and matching with Ag₂S/Ag reference electrodes, they are ready to obtain two H2S value for mutual measuring and marking; in addition, when using Zr/ZrO₂ as measuring electrodes and Ag/AgCl as reference electrodes, they are ready to obtain two pH value for mutual measuring and marking.

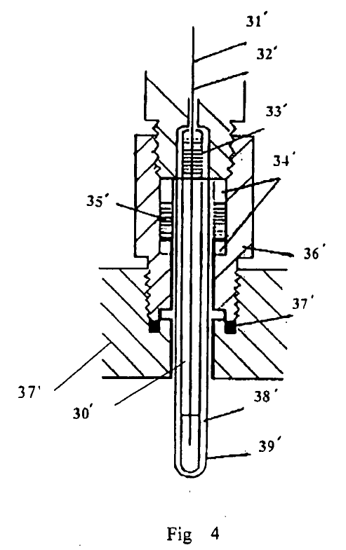

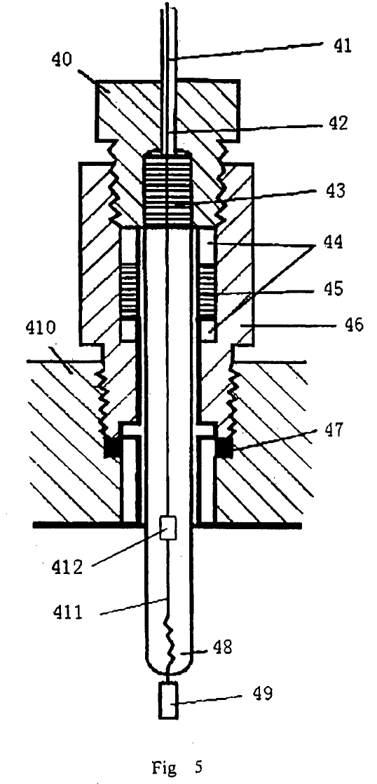

As illustrated in FIG. 4, the structure of the measuring electrode YSZ/HgO/Hg is:

Said YSZ/HgO/Hg electrode (also called YSZ/HgO/Hg ceramic probe) includes ceramic tube 39′ containing Y₂O₃ with one end sealed and the other open, in which Hg/HgO mixture 38′ is filled into the lower part of the ceramic tube; a piece of platinum wire 31 is inserted into said ceramic tube with its lower part buried into said Hg/HgO mixture and its upper part holding out of the ceramic tube to connect with a physical conducting wire or directly work as a physical conducting wire; filling substance 30′, which is silicate substance involved in no electrochemical reaction and solidified when water is added in, is put into the upper part of the ceramic tube above the Hg/HgO mixture; the filling substance will push down the Hg/HgO mixture firmly; PTFE or graphite-PTFE-mixture washers 33 are fitted on the ceramic tube end from where Pt wire 31 holds out to have said end of ceramic tube 39′ sealed; insulating layer 32′ is fitted over the non-conducting wire connection part of the Pt wire in said ceramic tube, which can be done with insulating heat-resistant coating and/or an insulating PTFE tube or a heat shrinkable PTFE tube sheathed on the Pt wire; the sealing structure fitted over said insulating layer is used to seal the part between sensor electrodes and through holes of the high pressure reactor, or between the sensor and the detector shell in field measuring.

The ceramic tube contains ZrO₂ as its major component along with 9% of Y₂O₃ stabilizer. Generally the ceramic tube is called “Y₂O₃Stabilized ZrO₂ Ceramic Tube”.

The silicate filling substance filled over Hg/HgO mixture can be cement slurry, while adding ceramic pipe nipples can enhance the filling's strength and consistence.

Said sealing structure for said ceramic probe (YSZ/HgO/Hg electrode) and the chemical sensor shell is to fit graphite-PTFE-mixture sealing washers on said electrode. In this example, the sealing washers adopts a configuration of alternately placing graphite-PTFE-mixture sealing washer 35′, stainless steel washer 34′, which are covered and pressed by metal thread ferrule 36′ and nut 39′ that screw into the through hole of the shell, forming the extruded sealing structure.

### Example 4

An integrated high-temperature/high-pressure chemical sensor that includes the Zr/ZrO₂ electrode as well as the Au (or Pt) electrode and the Ag/AgCl electrode, is capable of measuring pH value, Eh value and H₂ value simultaneously. Structures of the Zr/ZrO₂ electrode, the Au electrode and the Ag/AgCl electrode are same as those in Example 1. In addition, the Au electrode can be well replaced by the Pt electrode with exactly the same structure. Each of said electrodes has an insulating layer and a sealing structure sheathed over and is inserted into a through hole on a sensor shell for sealing and fastening.

### Example 5

Presenting an Au electrode with its structure and construct process same as those in Example 1.

### Example 6

Presenting an Ag/AgCl electrode with two structures and construct process same as those in Example 1.

### Example 7

Presenting an integrated high-temperature/high-pressure chemical sensor that replaces the Zr/ZrO₂ electrode in Example 1 and Example 4 with the YSZ/HgO/Hg electrode. In this example, structures for all electrodes and the sensor are same as those in Example 1.

Compared with those in Example 1 and Example 4, the sensor in this example is more durable and has longer lifespan at the temperature of 200-400

### Example 8

Presenting a Zr/ZrO₂ electrode and its construct process:

The structure of the Zr/ZrO₂ electrode is same as that in Example 1, while its construct process is basically similar to Example 1, except that there are more options for matching reaction temperatures and duration for the step of forming film ZrO₂ on the Zr wire:

1. Heating temperature for 1 hour at 900.

2. Heating temperature for 1.5 hours at 892.

3. Heating temperature for 1.2 hours at 896.

### INDUSTRIAL PRACTICABILITY

The Zr/ZrO₂ electrode and the integrated high-temperature/high-pressure chemical sensors it constitutes, as the invention presents, are capable of working at the temperature range between 0 and 400 under high pressure up to 60 MPa, and also able to accurately measure multiple electrochemical parameters and display working stability and long lifespan. Use of said high-temperature/high-pressure chemical sensors constructed by the Zr/ZrO₂ electrode can accurately measure multiple values including pH value, H₂ value, H₂S value and Eh value and show a high level of integrity.

1. A high-temperature/high-pressure Zr/ZrO₂ electrode, which is applied to construct the chemical sensors that are used to measure pH value, H₂ value, and H₂S value and applicable within the temperature range of 0-400° C. and under high pressures up to 60 MPa. It features a piece of Zr wire that is divided into the probe section at one end, the middle section and the conducting wire connection section at the other end, while on the Zr wire part of said probe section there is a layer of ZrO₂ and on said middle section there are an insulating layer and then a sealing structure in place.

2. The high-temperature/high-pressure electrode as in claim 1, which features that: a mechanical connection structure fitted on said conducting wire connection section, i.e. sheathing the conducting wire section of the electrode with an easily weldable conductive metal canula that is used for welding connection between the conducting wire and said conductive metal canula to form an electrode measuring circuit.

3. The Zr/ZrO₂ electrode as in claim 1, which features that said insulating layer covering over the exterior surface of the middle section is insulating heat-resistant coating and/or a PTFE tube or a heat shrinkable PTFE tube sheathed on the Zr wire.

4. The Zr/ZrO₂ electrode as in claim 1, which features that said sealing device is to sheathe graphite-PTFE-mixture sealing washers on the insulating layer or use the arrangement of alternately sheathing graphite-PTFE-mixture sealing washers and metal washers, and the sealing structure also includes metal thread ferrules and nuts, which are fitted on said sealing washers, screwing onto through holes of the chemical sensor shell.

5. The construct process for a Zr/ZrO₂ electrode is as follows:
Using the Zr wire with a diameter of φ1˜1.2 mm.
For the Zr wire with organic carbon coating, its probe section is directly put into an alumina crucible with Au lining, which gets oxidized in melted NaCO₃ and form ZrO₂ film on them after reacted for 1-1.5 hours at the temperature of 890-900° C.; or For the average Zr wire, cleansing procedure needs to be done first in following manners: to burnish the surface of the Zr wire and then dip it into thin hydrochloric acid which will remove soluble matters on its surface, rinse to get rid its surface of organic pollutants and dust; dry it and then perform the aforesaid oxidization process;
To connect the conducting wire connection end of the Zr/ZrO₂ electrode with the conductive metal pipe will adopt the manner of mechanically pressing, i.e.:
Burnishing the conducting wire connection section of the Zr/ZrO₂ electrode and then cover with and press said burnished end of the electrode to the conductive metal canula.

6. An integrated high-temperature/high-pressure chemical sensor, which features a Zr/ZrO₂ electrode and also 2-5 electrodes combined with the Zr/ZrO₂ electrode to measure pH value, H₂ value, H₂S value and Eh value in high-temperature/high-pressure conditions that are integrated to form an integrated chemical sensor able to detect at least two parameters presented above.

7. The integrated high-temperature/high-pressure chemical sensors as in claim 6, which feature:
Said Zr/ZrO₂ electrode that includes a piece of Zr wire which is divided into a probe section at on end, a middle section and a conducting wire connection at the other end. Thus a ZrO₂ layer is coated on the surface of the Zr wire in the aforesaid probe section, an insulation layer and sealing structure are fitted on the aforesaid middle section, along with a mechanical connection structure on the aforesaid conducting wire connection section.

8. The integrated high-temperature/high-pressure chemical sensor as claim 7, which features: Au (or Pt) electrodes, Ag/AgCl electrodes and Ag₂S/Ag electrodes. Said electrodes are sheathed with an insulating layer and a sealing structure, and packed and sintered in through holes of a chemical sensor shell.

9. The integrated high-temperature/high-pressure chemical sensor as in claim 8, which features: also including YSZ/HgO/Hg electrodes, which can be used to construct a 5-electrode chemical sensor.

10. The integrated high-temperature/high-pressure chemical sensor as in claim 7, which features: also including Au or Pt electrodes and Ag/AgCl electrodes, which can be used to construct a 3-electrode chemical sensor.

11. The integrated high-temperature/high-pressure chemical sensor as in claim 8, which features:
The structure design for said Ag/AgCl electrode is:
Placing AgCl film on Ag wire at the probe section of the electrode and insulting layers at non-probe sections and non-conductive wire sections of the electrode mention above, with Ag wire at the other end of the electrode for connecting conductive wires of measuring circuit while in use. Exterior of such insulting layer will have sealing structure in place to seal clearance between electrodes and through holes of the chemical sensor shell; or
The structure design for said Ag/AgCl electrode: a piece of Ag wire which is divided into the probe section at one end, the middle section and the conducting wire connection at the other end; the part of Ag wire on the probe section, which is coated with a AgCl film by melting solid AgCl powder, is placed into a ceramic tube with porous layers formed by sintered cement sealed at both of its ends; the probe section of the AgCl/Ag electrode is packed behind the sintered cement layer in the ceramic tube, while said middle section and the conducting wire connection pass through the sintered cement layer and connect with physical conducting wires at its end for circuit board connection; the probe section of such an electrode has a three-zone structure, cement-AgCl/Ag-cement; the part of Ag wire on said middle section has an insulating layer over it along with a sealing structure over the insulating layer.

12. The integrated high-temperature/high-pressure chemical sensor as in claim 8, which features:
Said Au electrode includes a quartz rod, a piece of alloy wire with thermal expansion coefficient similar to quartz's and a piece of Au wire; the alloy wire which is Kovar, and the Au wire are embedded in the quartz rod from one end to the other and attach to each other in the rod; a part of the Au wire leaves out of the measuring end of the quartz rod and a part of the alloy wire holds out of the other end of the quartz rod to connect physical conductive wires; the alloy wire and the Au wire are sealed and sintered in the quartz rod; the alloy wire that holds out of the quartz rod is coated with an insulating layer; a sealing structure is fitted over the insulating layer and on the sidewall of the quartz rod.

13. The integrated high-temperature/high-pressure chemical sensor as in claim 8, which features:
The structure of said Ag/Ag₂S electrode is: the part of Ag wire on the probe section is placed into a ceramic tube (zirconia ceramic tube or alumina ceramic tube or ordinary ceramic tube) with porous layers formed by sintered cement sealed at both of its ends and a solid Ag₂S layer inside the tube and around the Ag wire formed by melting solid Ag₂S powder; the probe section of the Ag/Ag₂S electrode is packed behind the sintered cement layer in the ceramic tube, while the conducting wire connection goes through the sintered cement layer and connects with physical conducting wires; the non-conducting wire section that goes through said sintered cement layer is coated with an insulating layer; a sealing structure is fitted over the insulating layer.

14. The integrated high-temperature/high-pressure chemical sensor as in claim 9, which features:
Said YSZ/HgO/Hg electrode includes a ceramic ZrO₂ tube containing Y₂O₃ with one end sealed and the other open, in which Hg/HgO mixture is filled into the lower part of the ceramic tube; a piece of platinum wire is embedded into said ceramic tube with its lower part buried into said Hg/HgO mixture and its upper part holding out of the ceramic tube; filling substance, which is silicate substance involved in no electrochemical reaction and solidified when water is added in, is put into the upper part of the ceramic tube above the Hg/HgO mixture; the filling substance will push down the Hg/HgO mixture firmly; the non-conducting wire connection section of the Pt wire that holds out the ceramic tube is coated with an insulating layer; a sealing structure is fitted over said insulating layer.

15. A high-temperature/high-pressure Au electrode, which is used in a chemical sensor to measure H₂ value and Eh value and applicable at the temperature range between 0° C. and 400° C. under the pressure up to 60 MPa with specific fabrication and construct processes, and features: a quartz rod, a piece of alloy wire with thermal expansion coefficient similar to quartz's and a piece of Au wire; the alloy wire which is Kovar, and the Au wire are embedded in the quartz rod from one end to the other and attach to each other in the rod; a part of the Au wire leaves out of the measuring end of the quartz rod and a part of the alloy wire holds out of the other end of the quartz rod to connect physical conductive wires; the alloy wire and the Au wire are packed and sintered in the quartz rod; the alloy wire that holds out of the quartz rod is coated with an insulating layer; a sealing structure is fitted over the insulating layer and on the sidewall of the quartz rod.

16. A high-temperature/high-pressure Ag/AgCl electrode, which is used in a chemical sensor to measure [H₂] pH value and Eh value and applicable at the temperature range between 0° C. and 400° C. under the pressures up to 60 MPa with specific fabrication and construct processes, and features:
Its structure design: placing AgCl film on Ag wire at the probe section of the electrode and an insulting layer at non-probe section and non-conductive wire section of said electrode, with Ag wire at the other end of the electrode for connecting conductive wires of measuring circuit while in use; exterior of such insulting layer will have sealing structure in place to seal clearance between electrodes and through holes of the chemical sensor shell; or
Including a piece of Ag wire which is divided into the probe section at one end, the middle section and the conductive wire connection at the other end; the part of Ag wire on the probe section is placed into a ceramic tube (zirconia ceramic tube or alumina ceramic tube or ordinary ceramic tube) with porous layers formed by sintered cement sealing at both of its ends; around the Ag wire is a AgCl layer made by melting solid AgCl powder; the probe section of the AgCl/Ag electrode is packed behind the sintered cement layer in the ceramic tube, while the middle section and the conductive wire connection go through the sintered cement layer and attach to physical conductive wires with its end for circuit board connection. The probe section of such an electrode has a three-layer structure, cement-AgCl/Ag-cement; the middle section is coated with an insulating layer; a sealing structure is fitted over the insulating layer.

17. A process to construct the Ag/AgCl electrode as in claim 16, which is achieved through following steps:
To produce an Ag/AgCl electrode, one of the following processes can be adopted:
(1) Melting AgCl at the temperature of 470° C.˜550° C. and putting the Ag wire into the melted AgCl, which forms a AgCl coating over the Ag wire, then taking it out; or
(2) Inserting the probe section of the Ag wire into the zirconia, or Al₂O₃ ceramic or ordinary ceramic tube which contains solid AgCl powder in its interior cavity with cement sealed at both ends of the tube and then heating parts mentioned above to at temperature of 500-550° C. for 1 to 3 hours, after which the solid AgCl powder will melt and form an AgCl coating over the Ag wire and cement sealing both ends of the ceramic tube will form porous sintered layers; during this process, the Ag wire as one end of the probe section is packed behind the sintered cement layer of the ceramic tube, while the other end of the Ag wire is passing through the sinter cement layer for power connection.

18. A high-temperature/high-pressure chemical sensor, which is used for measuring Eh value in high-temperature/high-pressure conditions and features: including Au electrodes and Ag/AgCl electrodes which are sheathed with an insulating layer and a sealing structure and packed and sintered in through holes of a chemical sensor shell.

19. The high-temperature/high-pressure chemical sensor as in claim 18, which features: the structure design for said Ag/AgCl electrode is:
Placing AgCl film on Ag wire at the probe section of the electrode and insulting layers at non-probe sections and non-conducting wire sections of said electrode, with Ag wire at the other end of the electrode to connect conducting wires of measuring circuit while being in use; over such an insulting layer will be sealing structure in place to seal parts between electrodes and through holes of the chemical sensor shell; such a sealing structure is achieved as follows: the graphite-PTFE-mixture sealing washer is put in place around the insulting heat-resistant coating in the middle section; electrodes are sheathed below such sealing washers with the insulating PTFE tube; the metal sealing washers is fitted on the PTFE tube; the heat shrinkable PTFE tube and the stainless steel tube are sheathed on electrodes above the graphite-PTFE-mixture sealing washer; the metal ferrule is fitted on the middle part with taper-shaped through holes at its center and supporting with its lower end upon the metal sealing washers; such graphite-PTFE-mixture sealing washers are supporting against through hold shoulders of the metal ferrules for the sealing purpose; a sealing pressure part is sheathed on the stainless steel canula above such a metal ferrule by screwing into the wider holes in the upper part of such a metal ferrule, to construct a two-fold baton sealing structure; or
Including a piece of Ag wire which is divided into the probe section at one end, the middle section and the conductive wire connection at the other end; the part of Ag wire on the probe section is placed into a ceramic tube (zirconia ceramic tube or alumina ceramic tube or ordinary ceramic tube) with porous layers formed by sintered cement sealing at both of its ends; around the Ag wire is a AgCl layer made by melting solid AgCl powder; the probe section of the AgCl/Ag electrode is packed behind the sintered cement layer in the ceramic tube, while the middle section and the conductive wire connection go through the sintered cement layer and attach to physical conductive wires with its end for circuit board connection. The probe section of such an electrode has a three-zone structure, cement-AgCl/Ag-cement; the middle section is coated with an insulating layer; a sealing structure is fitted over the insulating layer.

20. The high-temperature/high-pressure chemical sensor according to claim 18 features: the structure design for said Au electrode is:
Said Au electrode includes a quartz rod, a piece of alloy wire with thermal expansion coefficient similar to quartz's and a piece of Au wire; the alloy wire which is Kovar, and the Au wire are embedded in the quartz rod from one end to the other and attach to each other in the rod; a part of the Au wire leaves out of the measuring end of the quartz rod and a part of the alloy wire holds out of the other end of the quartz rod; the alloy wire and the Au wire are packed and sintered in the quartz rod; the alloy wire that holds out of the quartz rod is coated with an insulating layer; a sealing structure is fitted over the insulating layer and on the sidewall of the quartz rod.

21. The integrated high-temperature/high-pressure chemical sensor as in claim 11, which features: said insulating layer is insulating heat-resistant coasting and/or an insulating PTFE tube or a heat shrinkable PTFE tube sheathed on the Pt wire.

22. The integrated high-temperature/high-pressure chemical sensor as in claim 11, which features: said sealing device is to sheathe graphite-PTFE-mixture sealing washers on the insulating layer; or use the configuration of alternately sheathing graphite-PTFE-mixture sealing washers and metal washers, and the sealing structure also includes metal thread ferrules and nuts, which are fitted on said sealing washers, screwing onto through holes of the chemical sensor shell.
